(19) United States
(12) Patent Application Publication
(10) Pub. No.: US 2016/0019268 A1
(43) Pub. Date: Jan. 21, 2016

(54) USER-INTERFACE FOR PROVIDING A STACK VIEW OF AN E-BOOK COLLECTION

(71) Applicant: Kobo Inc., Toronto (CA)

(72) Inventors: Sneha Patel, Mississauga (CA); Ghazaleh Etezal, Toronto (CA)

(21) Appl. No.: 14/335,764

(22) Filed: Jul. 18, 2014

(51) Int. Cl. G06F 17/30

(52) U.S. Cl. CPC G06F 17/30554; G06F 17/30997; G06F 17/30598; G06F 17/30867

(57) ABSTRACT

A criterion for defining a collection is determined based on user input or data contained on the computing device. The content items that are part of a user library and which are part of the collection are identified based at least in part on the criterion. A stack representation of the collection is displayed. A content for a foreground of the stack representation is also selected, where the content selected for the foreground is specifically relevant to the collection.

### TECHNICAL FIELD

Examples described herein relate to a user-interface for a computing device, and more specifically, to a user-interface for providing a stack view of an e-book collection.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

Some electronic personal display devices are purpose built devices that are designed to perform especially well at displaying readable content. For example, a purpose built purpose build device may include a display that reduces glare, performs well in high lighting conditions, and/or mimics the look of text on actual paper. While such purpose built devices may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links a device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for organizing an e-book collection, according to an embodiment.

FIG. 2 illustrates an example of an e-reading device for use with one or more embodiments described herein.

FIG. 3 illustrates an example device system for providing a stack view of a collection, according to an embodiment.

FIG. 4 illustrates an example method for displaying a stack representation of a collection of content items.

FIG. 5A through FIG. 5C illustrate examples of objects which are stack representations of e-books.

FIG. 6A and FIG. 6B illustrate an example of a user interface on which a stack representation of a collection is provided.

### DETAILED DESCRIPTION

Examples described herein provide for a system, device and method for organizing collections of content items using graphic stack representations. Among other benefits, examples such as described herein enable, for example, a content library to be organized in a manner that is personal to the user (e.g., based on categories such as the user's favorite author), and further in a manner which conveys information about content items of the user library by group or cluster. Such an organization can enable a better user navigation experience amongst a larger library of content items.

In an embodiment, content items of a library are organized on a computing device through rendering of stack representations for corresponding collections of content items. In particular, a criterion for defining a collection is determined based on user input or data contained on the computing device. The content items that are part of a user library and which are part of the collection are identified based at least in part on the criterion. A stack representation of the collection is displayed. A content for a foreground of the stack representation is also selected, where the content selected for the foreground is specifically relevant to the collection.

“E-books” are a form of an electronic publication that can be viewed on computing devices with suitable functionality. An e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., e-reading apps) to view e-books. Still further, some devices (sometimes labeled as “e-readers”) can be centric towards content viewing, and e-book viewing in particular.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Overview

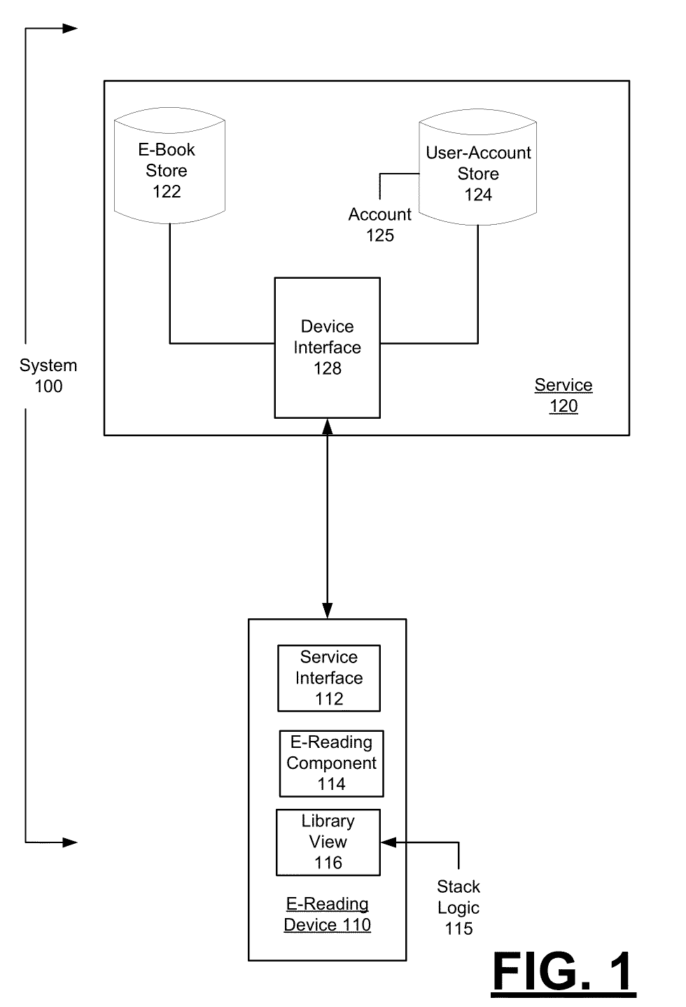

FIG. 1 illustrates a system for organizing an e-book collection, according to an embodiment. In an example of FIG. 1, system 100 includes an e-reading device 110 and a network service 120. The network service 120 may include multiple servers and other computing resources that provide various services in connection with one or more applications that are installed on the e-reading device 110. By way of example, in one implementation, the network service 120 can provide e-book services which communicate with corresponding e-book functionality provided on the e-reading device 110. The e-book services can enable e-books to be downloaded or archived from e-reading device 110. The network service 120 can also provide other forms of content for download or streaming, such as videos or music. In this way, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can correspond to a mobile computing device (e.g., tablet) that runs an e-reading application to link the device to the network service 120 in order to enable e-books provided through the service to be viewed and consumed. Still further, by way of example, the e-reading device 110 can be equipped with hardware and software to optimize certain application activities, such as rendering of electronic content (e.g., e-books). For example, the e-reading device 110 can have a tablet like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., content item such as an e-books), which can be stored in the resource store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

The e-reading device 110 can include a service interface 112, an e-reading component 114 and a library view component 116. The e-reading device 110 can execute the service interface 112 to receive resources and data from the network service 120. The service interface 112 can signal the network service 120 an identifier for the user and/or user account. The service interface 112 can interface with the network service 120 to receive resources such as applications and content items (e.g., e-books, music files, etc.) from the network service. Optionally, the e-reading device 110 can communicate with multiple services in order to receive resources.

The e-reading device 110 can execute the e-reading component 114 to enable e-reading activities. In particular, the e-reading component 114 can render paginated content from e-books (e.g., electronically formatted literary works, including periodicals).

The library view component 116 can include a user interface that provides a presentation of the content items (e.g., e-books, including magazines and periodicals) in a defined library. The library can include the user's entire collection of e-books, as well as e-books that are being promoted or otherwise displayed through metadata content on the user device. For example, a library can include e-books in a user collection and/or e-books that network service 120 is promoting and/or making available for purchase or download. The presentation of the content items can be based on metadata content associated with the individual content items. For example, in the case of e-books, the metadata content used to display representations of the e-books in the user library can include images provided by the publisher (e.g., icons or graphic objects) which represent or appear as a book cover or jacket. Likewise, in the case of music or movies, representations of the content items in the user's library can be based on icons or graphic objects that represent album art (music) or box cover art (movies).

The library view component 116 can generate presentation of e-books or other content items of the user's library using a variety of paradigms. For e-books in particular, the library view component 116 can display the metadata content of the e-books (e.g., icons representing book or magazine covers) in the form of lists, or on a virtual bookshelf that is personalized for the user library (e.g., a book shelf displaying portions of icons representing book covers, magazine covers and/or comic book covers which are in the user library).

Furthermore, in some embodiments, the library view component 116 includes stack logic 115 which generates presentations in which e-books in the user library are identified as belonging to a collection, and individual the collections can be identified in a variety of ways collections of the user library are displayed to the user in the form of a stack.

The stack logic 115 can identify one or more criterion for determining a collection that is to be graphically represented as a stack. The criterion can be programmatically determined from, for example, user input or from data contained on the e-reading device or otherwise associated with the user account. As an example, the criterion can correspond to a favorite author of the user, which can be identified by user input, analysis of data contained on the user device (e.g., count of e-books by author on the user device), and/or by profile information that is obtained from user interaction with network service 120 (e.g., what e-books the user purchases, previews, or pre-orders). In this way, literary works can be determined to be part of a common collection based on criteria that includes authorship, literary theme or category, common characters, or other designations (e.g., literary works that are part of a series). In the case of the electronic periodical such as magazines and comic books, a collection can correspond to a particular periodical, which can be identified by a periodical title, volume and/or issue number or identifier (e.g., month or year). The collections can be identified in a variety of ways. In one implementation, collections can be associated with tags or headings (e.g., lists) provided by the network service 120. In variations, user input can identify a collection in the form of a list of content items that the user has associated together (e.g., user creates a favorite lists). Still further, a collection can be identified programmatically through analysis of, for example, metadata associated with the content item (e.g., category headings).

The stack logic 115 can further execute to provide a graphic representation of a given collection. In one implementation, the stack representation can be provided for e-books that are part of the user library. In variations, the stack representation can include graphic indicia for e-books which are not part of the user library (e.g., metadata content that is pushed from network service 120 as promotional). The stack representation can be in the graphic form of a stack that includes metadata content reflecting a particular e-book or content item (or set thereof). In one implementation, the rendering of metadata content can reflect the stack logic implementing a priority scheme for selecting metadata content that is to be the predominant component of the stack representation. In this way, the stack logic 115 can prioritize individual e-books of the collection to appear as being on top of the stack, or near the top.

In one aspect, the stack representation of a collection can include metadata content for one or multiple select e-books of the collection which have a priority designation over other e-books of the collection. For example, in the case of e-book collections, a stack representation of a collection can include, as its most prominent graphic component, metadata content from a specific e-book in the collection. For example, a foreground image of a stack representation can include metadata content from an e-book of the collection that is prioritized based on criterion that includes one or more of (i) being most recently published e-book of the collection (e.g., most recent magazine or issue of a periodical), (ii) being most recently obtained (e.g., purchased) e-book of the collection, (iii) being unread or partially unread (e.g., being read), (iv) being the e-book that is most often read (e.g., by frequency, or time spent reading), and/or (v) being the e-book that is designated as a user-favorite in the collection. By way of further example, an e-book collection can be defined by authorship, and the prioritization scheme can reflect an author's most popular title (e.g., to the general population), the most recently published title, the title that has sold the most copies, and/or the title the user most (recently read or is currently reading).

Hardware Description

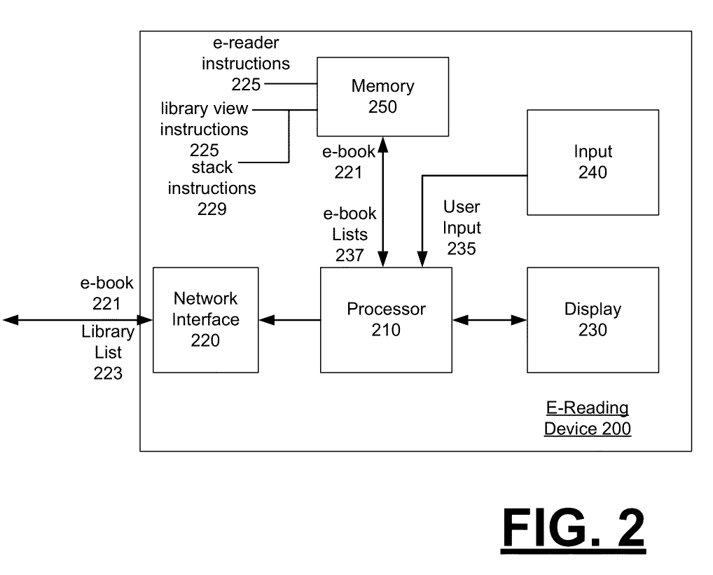

FIG. 2 illustrates an example of an e-reading device for use with one or more embodiments described herein. In an example of FIG. 2, an e-reading device 200 can correspond to, for example, a mobile computing device such as shown by an example of FIG. 1.

With reference to FIG. 2, e-reading device 200 includes a processor 210, a network interface 220, a display 230, one or more input mechanisms 240, and a memory 250. The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests etc.). For example, e-reading device 200 can receive application resources, such as media files (e.g., e-books 221) that the user elects to purchase or otherwise download from the network service 120. The application resources that are downloaded onto the e-reading device 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230.

In one aspect, memory 250 stores instructions 225 (“e-reading instructions 225”) for operating an e-reading application (e.g., see e-reader component 114 in FIG. 1). The memory 250 can also store library view instructions 227 for providing a library view component (e.g., see library view 116 in FIG. 1). Additionally, the memory 250 can include instructions 229 for providing stack logic 115 (see FIG. 1) (“stack instructions 229”). The processor 210 can execute the library view instructions 227 to display various forms of lists representing the collection of e-books 221 in the user collection. The processor 210 can execute the stack instructions 229 to (i) identify collections in the user library, and (ii) render a stack representation of the identified collection using display 230. The identified collections used by the stack logic 229 can include lists which are defined by, for example, the network service, data provided on the e-reading device 200 or through user input 235. For example, user input 235 can be provided through a touch screen to identify the e-books that the user wishes to identify as part of a user-defined collection.

Device System

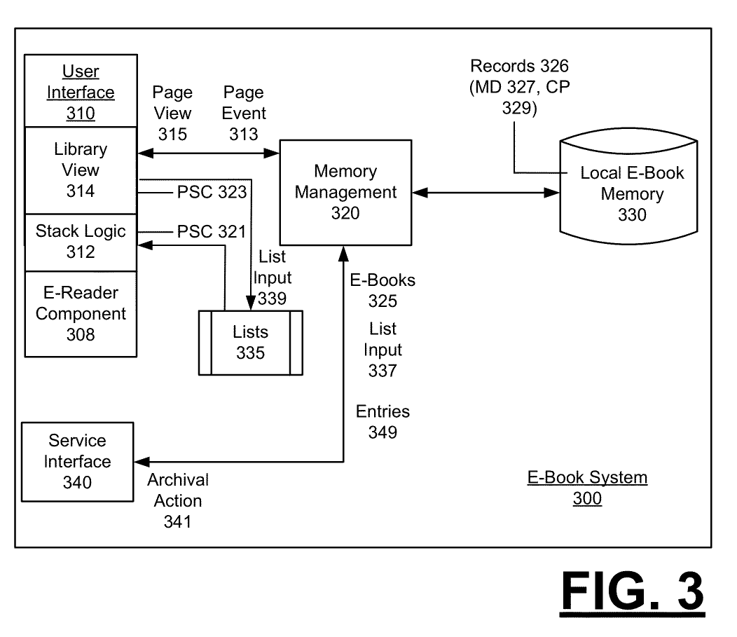

FIG. 3 illustrates an example device system for providing a stack view of collections in a user's e-book library, according to an embodiment. In reference to FIG. 3, a system 300 implements programmatic components for communicating with one or more network service (such as network service 120, shown in FIG. 1), as well as for enabling functionality for viewing and accessing content items (e.g., e-books) utilized by an account associated with the e-reading device 110 (see FIG. 1). In some embodiments, the system 300 can be implemented as an application that runs on an e-reading device, such as shown with examples of FIG. 1 or FIG. 2. In variations, the system 300 can be implemented as part of the operating system for the e-reading device.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reading device 110 (see FIG. 1). For example, the user can download an application onto the device that is operated as the e-reading device 110, in order to obtain functionality such as described with an example of FIG. 3, as well as to communicate with the network service 120. Alternatively, an application can be embedded or otherwise preinstalled with other programmatic elements for providing functionality such as described with system 300.

The service interface 340 includes application logic which enables the e-reading device 110 to use, for example, a wireless Internet connection, to connect to the network service 120 (see FIG. 1). In connecting with the service, the service interface 340 can transmit data that enables the network service 120 to identify the e-reading device 110 on which system 300 is implemented, so that the network service 120 can determine the account that is associated with the particular e-reading device. The service interface 340 can be used to retrieve e-books 325 from the network service 120. For example, in identifying the e-reading device 110 of system 300 to the network service 120, the network service may be able to procure payment information (e.g., stored credit card information) that can be used to charge the user's account when the user purchases a new e-book from the service. Each e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Individual e-books 325 also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reading device of system 300, the network service 120 can identify what e-books belong to the account associated with the particular device. The e-books that are transmitted to the e-reading device of system 300 can include, for example, those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reading device 110 to automatically receive their previously purchased e-book. As another example, network service 120 can be configured to push e-books to the e-reading device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reading device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The management module 320 can retrieve portions of the content 329 for individual e-books for purpose of rendering e-books via the user interface 310. Additionally, the management module 320 can retrieve metadata 327 to render metadata content (e.g., representations of e-books or lists of e-books) with the user interface 310.

In an example of FIG. 3, the user interface 310 of e-book system 300 includes an e-reading component 308 and a library view component 314. Additionally, stack logic 312 can be provided with the library view component 314. The e-reading component 308 can include functionality to (i) render page views 315 from a particular e-book, and (ii) detect page events 313. The page views 315 can include the content portion 329 of the e-book being read (e.g., opened or rendered). For example, the e-reading component 308 can display a page view 315 from an e-book corresponding to a novel or periodical, and the page view may include text and/or image content. The page event 313 can correspond to, for example, a page turn, a chapter turn, or a clustered page turn.

The library view 314 can display objects and metadata that represent individual e-books and content items of the user library. In one implementation, the library view 314 can display metadata content based on the metadata portion 327 of individual e-books that are in the user library. The e-books that are in the user library can correspond to e-books stored with local memory 330, as well as archived e-books that are provided remotely (e.g., provided on network service 120).

More specifically, in some implementations, the memory management module 320 can be triggered into archiving e-books. In archiving an e-book, the content portion 329 of the e-book can be removed from the local memory 330, while the metadata portion 327 of the record 326 remains stored in the local memory 330. The trigger for archiving e-books can be based on the user input, or generated programmatically in response to events such as memory management processes (e.g., process to archive e-books that have been read; process to detect when free memory is below threshold, etc.). The library view component 314 can display the representation of the archived e-books using the metadata content 327.

In one implementation, stack logic 312 can execute as part of the library view component 314. The stack logic 312 can receive, as input, one or more lists 315 that define collections of e-books, and render stack representations of each collection. For example, multiple lists 315 can be maintained, and each less can identify one or more e-books in the corresponding collection. In a variation, the list can include e-books that are locally stored as well as those e-books which are part of the user collection, but archived. The list 335 can be defined from a variety of sources. In one implementation, the list 335 is defined through user input 339, which can be provided through, for example, the library view component 316. As an addition or variation, list input 337 can be received from an external source, such as from network service 120 (see FIG. 1). Still further, the stack logic 312 (or other programmatic mechanism) can include logic for programmatically defining at least a portion of one or more lists 315. The logic can scan or otherwise analyze data on the e-reading device in order to obtain criterion for determining the lists. For example, the logic can determine a favorite author of the user or a favorite subject matter of the user, and the favorite author or subject matter can define collections on the user device.

Still further, additional entries 349 to the lists 335 can be provided from the network service 120. For example, in the example in which the collections reflect titles by author, the network service 120 (see FIG. 1) can provide metadata for e-books that the user does not own or possess. Such metadata content can be provided to the user in order to promote e-books that the user can purchase.

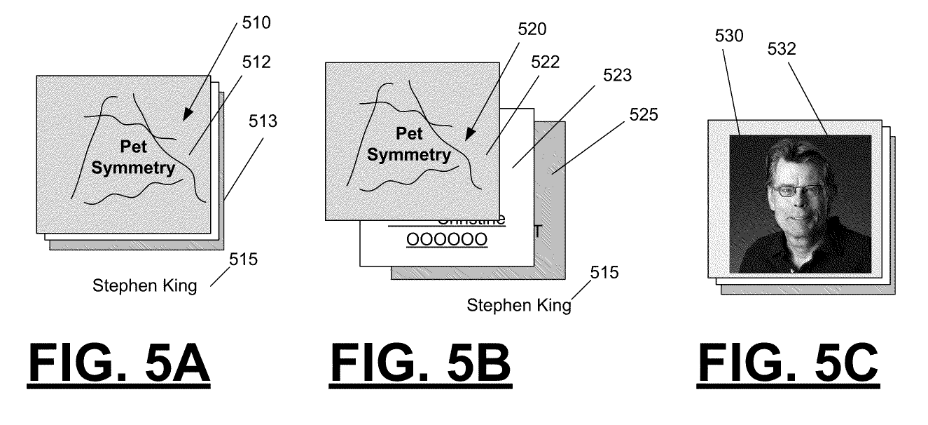

The stack logic 312 can generate graphic representations of individual list 335, so that individual collections (e.g., as defined by corresponding list 335) can be represented graphically in the form of a stack of multiple items. As illustrated with an example of FIG. 5A and FIG. 5B, individual stacks can include a foreground image that simulates a topmost item in a virtual stack. This foreground image can correspond to a particular e-book. The selection of which e-book is used for the foreground image of the graphic stack representation can be based on a priority scheme 321, which can be implemented by the stack logic 312. The priority scheme 321 can be based on user preference or default settings. By way of example, the priority scheme 321 can provide for the foreground image of a particular stack to include or be substantially provided by the metadata content of (i) a most recently published e-book of a collection (e.g., most recently published issue of a periodical); (ii) a most recently acquired e-book of the collection; (iii) an e-book that the user is currently reading; (iv) an e-book that has not been read yet; (v) an e-book that is the most frequently e-book read in the collection; (vi) an e-book that is designated by the user as being a favorite from the collection; or (vii) an e-book that is from a user's favorite author.

In the case where collections are defined by authorship, the prioritization scheme can reflect an author's most popular title (e.g., to the general population), the most recently published title, the title that has sold the most copies, and/or the title the user most (recently read or is currently reading). In the case where the collections are defined in part by authorship, the prioritization scheme can reflect an author's most popular title (e.g., to the general population), the most recently published title, the title that has sold the most copies, and/or the title the user most (recently read or is currently reading).

Still further, the priority scheme 321 can prioritize rendering metadata content corresponding to entries 349 received from an external source, such as the network service 120. For example, the entries 349 can include metadata content from a recently published title of an author that is determined to be a favorite of the user. The metadata content can be prioritized with respect to its display with the stack representation for the particular author.

The stack representations provided by the stack logic 312 can also display metadata content from e-books that are archived or otherwise not readily available on the e-reading device (e.g., metadata content for e-books that are received from the network service 120 as entries 349). In some implementations, the metadata content of e-books which are not locally provided, or which require additional action such as purchase or download, can be modified to reflect the difference in the availability of the e-book. For example, metadata content for e-books that are archived or pushed from network service 120 for promotional purposes can be made translucent or visually distinguishable from metadata content of other e-books.

While the priority scheme 321 can select the metadata content of the particular e-book that is in the foreground, the priority scheme 321 can also select metadata content from one or more e-books that are partially visible and occluded in the stack representation. Such e-books can be viewed as being second (or third, etc.) in priority, based on considerations mentioned above with regard to implementing the priority scheme 321 (e.g., second most recently published e-book or periodical, etc.).

In some variations, the library view component 314 can also implement a second priority scheme 323 in the manner in which stack representations of individual collections are displayed. For example, a user can maintain multiple lists 315 of e-books for a variety of purposes, but some lists 315 may have more importance or significance to the user and others. For example, a list of e-books that the user is currently reading can have more significance than a list of archived e-books. Likewise, lists (or stacks) which have more items can be deemed more significant. When collections reflect authorship, the list for the user's most favorite authors can be prioritized. The user's most preferred authors can be identified, by for example, (i) monitoring the number of e-books from a given author that the user purchases or downloads, or (ii) the priority scheme 323 for displaying stack representations of collections can sequence or order the display of individual stack representations on a user interface in a manner that reflects a priority of a corresponding collection over other collections. For example, the most significant list of e-books can be provided through a stack representation that is in the leftmost corner of a particular window or panel. As a variation, the most significant list can be provided in a stack representation that is larger, or otherwise in more prominence (e.g., central, a large etc.) relative to stack representations of other lists.

Methodology

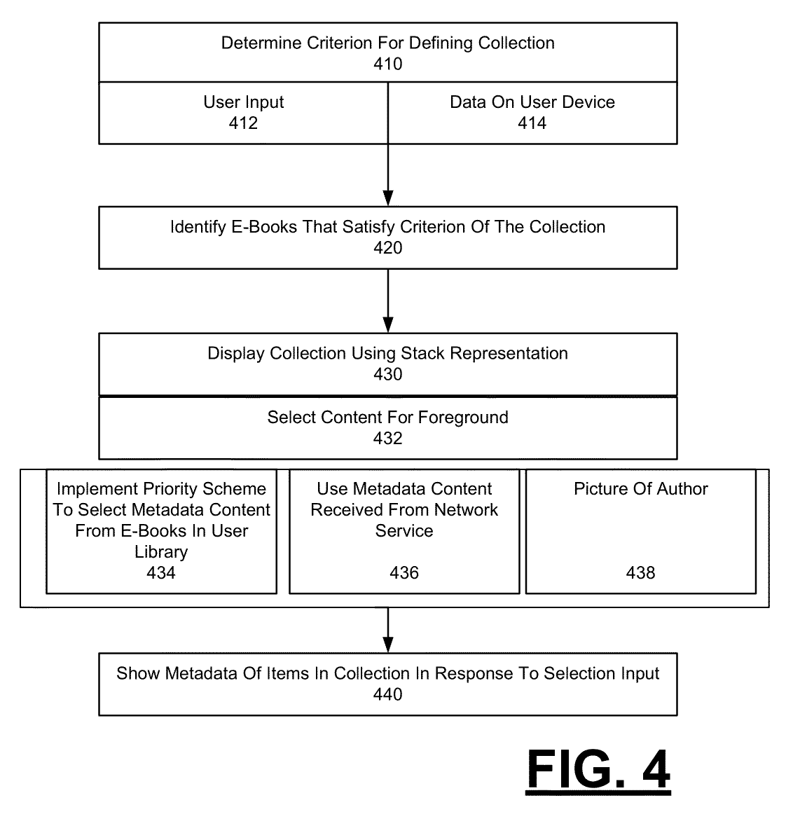

FIG. 4 illustrates an example method for displaying a stack representation of a collection of content items from a user's library of content items. An example such as described by FIG. 4 can be implemented using components such as described with FIG. 1, FIG. 2, or FIG. 3. Accordingly, reference may be made to elements of other figures for purpose of illustrating suitable elements or components for performing a step or sub-step being described.

With reference to FIG. 4, a criterion for defining a collection can be determined in connection with defining relevant collections for a user's e-book library (410). In one implementation, the collection can be defined based on user input (412). For example, the user can specify input that defines a collection based on a favorite author, subject matter, or other user-defined category. In a variation, the collection can be defined based on data contained in the user device (414). For example, the data on the user device can identify specific authors or subject matter interest of the user that are preferred or of interest. In some variations, an identified collection can include locally stored content items as well as archived content items. The archived content items can be stored with, for example, network service 120 or other memory or account resource external to the e-reading device.

The e-books in the user library that satisfy the criterion of the collection are then identified (420). For example, when the criterion of the collection reflects a favorite author of the user, the e-books in the collection may reflect literary works of the author. In some variations, e-books that are not in the user possession can also be identified in order to promote the user expanding his library.

Each collection can be graphically represented on a user-interface of an e-reading device in the form of a stack (430). In one implementation, the user interface can be provided as part of a library view, where a user can browse the contents of the user's library. For example, the user can view the contents of the user library in a variety of formats, including a list format, as well as in a format in which collections are displayed in a stack representation. The particular format for display in the collections of the user's library can be selected by the user.

A content is programmatically selected for the foreground (or most prominent location) of the stack (432). The programmatic selection of the foreground content can be based on, for example, the criterion and/or data contained on the device.

In one implementation, the foreground is based on metadata content of an item in the collection. A priority scheme may be implemented for displaying at least the foreground image of the stack (434). The foreground image can be provided by metadata content of an e-book (or other content item) in the collection that is selected to have the most prominence in display. The selection of the particular e-book that is to have the prominence (e.g., foreground display metadata content) can be based on the priority scheme. The priority scheme can designate criteria or conditions by which an e-book is to be selected for prominence with regard to the display of its metadata content within the stack representation. By way of example, the criteria or conditions can include: the selected e-book that is most recently published; the e-book that is most recently obtained; the selected e-book that is the most unread in the collection; the selected e-book that is currently being read; and/or the selected e-book that is a user favorite. As an addition or variation, the priority scheme can specify when a particular e-book is to have priority over another e-book. For example, a locally stored and available e-book can be deemed to have priority over an archived e-book which includes portions stored off-device (e.g., presumably because the user has read the archived e-book). In the case where collections are defined by authorship, for example, the prioritization scheme can reflect an author's most popular title (e.g., to the general population), the most recently published title, the title that has sold the most copies, and/or the title the user most (recently read or is currently reading).

As an alternative or variation, an e-reading device can receive metadata content from a network service or other external source reflecting e-books (or other content items) that are not in the user's possession. For example, network service 120 can push metadata content, corresponding to an e-book from the user's favorite author. The metadata content from the network service 120 can, for example, serve as promotional content to prompt the user interest and purchase. In some variations, the metadata content from the network service is prioritized or otherwise used for the foreground image of the stack representation (436), even though other e-books of the collection are in the user possession.

Still further, when the criterion for defining collections corresponds to authorship, the foreground image for the stack representation can correspond to an image of the author (438). The image of the author can be retrieved as a portion of the metadata content for one of the e-books in the collection, or alternatively, from a publisher source or network source. More generally, the foreground image selected for a stack representation of the collection can be an image that is deemed specifically relevant to the e-books of the collection. For example, if the criterion for the collection corresponds to “Hawaii” and the e-books pertain to Hawaii, the image selected for the foreground of the stack can correspond to an image of Hawaii that is obtained from a source other than the metadata of the e-books in the collection.

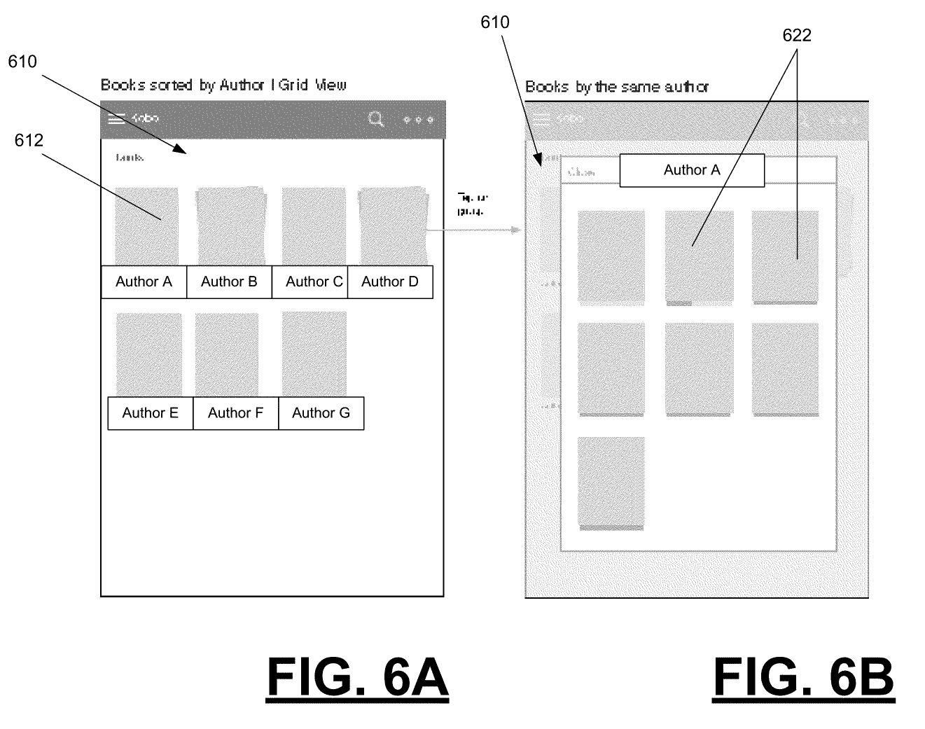

When the stack representation is selected by the user, one embodiment provides that metadata content of items in the collection are individually displayed (440). For example, metadata content of e-books in a collection can be displayed as a panel or list once the stack representation of the collection is selected. FIGS. 6A and 6B illustrate examples of when a stack representation of the collection is selected to display metadata content of individual items that form the collection.

### Examples

FIG. 5A through FIG. 5C illustrate examples of objects which are stack representations of e-books. FIG. 6A and FIG. 6B illustrate an example of the user interface on which a stack representation of the collection is provided. Examples such as provided by FIG. 5A through FIG. 5C and FIG. 6A and FIG. 6B can be implemented using embodiments such as described with FIG. 1 through FIG. 4. Accordingly, for purpose of description, references made to elements of prior examples for purpose of illustrating content and components for implementing interfaces and functionality such as described.

In FIG. 5A, a stack representation 510 is provided for a collection of e-books that is grouped by author (e.g., Stephen King). The stack representation corresponds to graphics object (or multiple objects), such as in the form of one or more icons. A portion of the stack representation represents the foreground image 512. The foreground image 512 can convey content that is based on one of the items in the collection. As provided with other examples, the selection of the e-book that is to provide metadata content for the foreground image 512 of the stack representation 510 can be based on the priority scheme. To further illustrate, metadata content of the e-book that the user is reading can be rendered in prominence (e.g. in the foreground) for the stack representation.

In some variations, the stack representation 510 can be selective in regards to the amount or portion of metadata content being displayed in the foreground. For example, the stack representation can be displayed with an additional identifier 515 which identifies the criteria on which the collection is based (e.g., author as shown in FIG. 5A, subject matter, user-defined category, etc.). If the stack representation represents the collection by author, the identifier 515 can identify the author. Optionally, the portion of the metadata content which displays the author's name can be removed from the graphic representation 510, in favor of other aspects of the book cover image (e.g., graphic or book title name).

The stack representation 510 can have one or more configurations in terms of the manner in which items provided in the stack are displayed in the graphic representation. In an implementation of FIG. 5A, the graphic representation provides a prominent rendering of the foreground image 512, and other elements of the stack are not provided any meaningful rendering. Thus, for example, the foreground image 512 conveys metadata content from a selected e-book, while a background image 513 shows outlines of other elements of the stack.

Still further, in one variation, the number of items that are in the stack is not discernible when viewing the stack representation 510. For example, when the stack includes multiple items, the stack representation can be rendered to display the foreground image, and one or more outline items as the background image.

In some variations, the stack 510 can include e-books of the user's library, as well as one or more e-books that are available to be made part of the user library. For example, network service 120 may push metadata content of the user's preferred author to the e-reading device 110. The metadata content can, for example, reflect an available title from the particular author, or an advance order for the next title from the author. In such instances, the metadata content from the network service 127 can be displayed in the foreground, for example, to promote user interest and purchase.

As still another addition or variation, the stack 510 can include metadata content from e-books that are archived. For example, the metadata content for the e-book in the foreground image 512 can be archived. When the e-book is archived, the metadata content can optionally be modified to reflect the archived status. For example, the metadata content of the archived e-book can be displayed in the stack representation to have translucent form.

FIG. 5B illustrates a stack representation 520 in which metadata content from multiple items of a collection are at least partially discernible in the stack representation. For example, the stack representation 520 can include a prominent or foreground image 522 provided by metadata content of a selected e-book which is overlaid on the metadata content of another e-book. The prominence of the e-book represented by the foreground image 522 can be deemed more significant than that of the e-book of the underlying image 523. A priority scheme can select which e-book is in the foreground, as well as the e-book that is to provide the metadata content for the second image 523 and/or third image 525 (or so forth).

As described with an example of FIG. 5A, the metadata content for e-books appearing in the stack as either foreground or second/third image can be altered to reflect a status of the underlying content item. For example, the metadata content can be made translucent to reflect the e-book is archived and available for download, or alternatively not yet purchased and/or available on pre-order.

FIG. 5C illustrates still another variation in which a stack representation 530 is provided a foreground image 532 that is shared amongst the contents of the collection. In the example provided, the collection represents e-books from a common author (Stephen King). Rather than show metadata content from an individual e-book, the metadata content from the stack can be selected to be one that can be shared amongst the e-books of the corresponding collection (e.g., picture of the author from which the collection is based).

With reference to FIG. 6A, a user-interface 610 includes multiple stack representation 620, each of which represent a collection of the users library. By way of example, the user-interface 610 can be implemented through the library component 314 (see FIG. 3). When multiple collections are present, the stack representations can be provided in a variety of formats. For example, the user interface 610 can display multiple stack representations 620 as a panel array. In one implementation, the rendering of multiple stack representations 620 can be included on a panel or other user-interface, using, for example, alphabetical listing (e.g., for collections by authorship). Alternatively, the arrangement of the stack representations 620 can be based on a separate priority scheme. For example, collections that are deemed more important or relevant to the user (e.g., those collections with the user reads more often) can be displayed in a more prominent position on the panel array (e.g., top left corner). Thus, for example, stack representations can be prioritized through positional placement (e.g., left-to-right placement), dimensionality variations amongst stacks, and/or other visual effects.

When collections, for example, represent titles of an authorship, the stack representations 610 can be prioritized to reflect the user's preferred author. For example, the user's preferred author can be determined from (i) the number of e-books that the user owns for a particular author, (ii) recent previews (or number of previews) that the user downloaded for the particular author, and/or (iii) purchasing activity of the user for a particular author (including pre-ordering e-books).

With reference to FIG. 6B, each stack representation 620 provided with the user-interface 610 can be selectable in order to display graphic representations 620 of the content item that form the collection. In the example provided, a given stack representation 620 (see FIG. 6A) can be selected in order to display metadata content 622 representing each e-book in the collection on the user-interface 610. For example, the metadata content 327 (see FIG. 3) for an e-book can be displayed when a given stack representation 620 is selected.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for organizing content items on a computing device of a user, the method comprising:
determining a criterion for defining a collection based on user input or data contained on the computing device;
identifying content items that are part of a user library and which are part of the collection based at least in part on the criterion; and
displaying a stack representation of the collection, including selecting content for a foreground of the stack representation, the content being specifically relevant to the collection.

2. The method of claim 1, further comprising:
in response to user selection input provided in connection with the stack representation, displaying metadata content for individual content items of the collection.

3. The method of claim 1, wherein displaying the stack representation includes displaying metadata content from one or more content items of the collection, and implementing a priority scheme to select the metadata content of the content item that is to be displayed in the foreground of the stack representation.

4. The method of claim 1, wherein the criterion includes an author, and wherein identifying content items that are part of the user library includes identifying e-books in the user library which are authored by the author.

5. The method of claim 4, wherein selecting content for the foreground includes displaying a picture of the author for the foreground.

6. The method of claim 1, wherein selecting content for the foreground includes receiving metadata content for a given e-book that is not in the user possession, the metadata content being provided from a network service, and displaying the stack representation using the received metadata content as the foreground for the stack representation.

7. The method of claim 2,
wherein selecting content for the foreground includes receiving metadata content for a given e-book that is not in the user possession, the metadata content being provided from a network service, and displaying the stack representation using the received metadata content as the foreground for the stack representation, and
wherein displaying metadata content for individual content items of the collection includes enabling the user to obtain possession of the given e-book by providing selection input in connection with the received metadata content of the given e-book.

8. The method of claim 3, wherein implementing the priority scheme includes selecting an e-book from which a corresponding metadata content is to appear in the foreground of the stack representation based on one or more criteria that includes at least one of (i) the selected e-book is a most recently obtained e-book in the collection, (ii) the selected e-book is a most unread e-book in the collection, (iii) the selected e-book is currently being read, and/or (iv) the selected e-book is a user favorite.

9. The method of claim 3, wherein the criterion includes an author, and wherein implementing the priority scheme includes selecting an e-book from which a corresponding metadata content is to appear in the foreground of the stack representation based on one or more criteria that includes at least one of the author's most popular or widely sold title.

10. The method of claim 1, wherein displaying the stack representation includes displaying metadata content from a content item that has been archived from the computing device, so that at least a content portion of the content item is not resident on the computing device.

11. The method of claim 10, wherein the metadata content from the content item that has been archived is displayed with a visual effect to indicate an archived status of the content item.

12. A computing device comprising:
a memory that stores a set of instructions;
one or more processors that use instructions from the memory to:
determine a criterion for defining a collection based on user input or data contained on the computing device;
identify content items that are part of a user library and which are part of the collection based at least in part on the criterion; and
display a stack representation of the collection, including selecting content for a foreground of the stack representation, the content being specifically relevant to the collection.

13. The computing device of claim 12, wherein the one or more processors use the instructions from the memory to:
in response to user selection input provided in connection with the stack representation, display metadata content for individual content items of the collection.

14. The computing device of claim 12, wherein the one or more processors display the stack representation by displaying metadata content from one or more content items of the collection, and by implementing a priority scheme to select the metadata content of the content item that is to be displayed in the foreground of the stack representation.

15. The computing device of claim 12, wherein the criterion includes an author, and wherein the one or more processors identify content items that are part of the user library by identifying e-books in the user library which are authored by the author.

16. The computing device of claim 15, wherein the one or more processors select content for the foreground by displaying a picture of the author for the foreground.

17. The computing device of claim 12, wherein the one or more processors select content for the foreground by (i) receiving metadata content for a given e-book that is not in the user possession, the metadata content being provided from a network service, and (ii) displaying the stack representation using the received metadata content as the foreground for the stack representation.

18. The computing device of claim 13,
wherein the one or more processors select content for the foreground by (i) receiving metadata content for a given e-book that is not in the user possession, the metadata content being provided from a network service, and (ii) displaying the stack representation using the received metadata content as the foreground for the stack representation, and
wherein the one or more processors display metadata content for individual content items of the collection by enabling the user to obtain possession of the given e-book by providing selection input in connection with the received metadata content of the given e-book.

19. The computing device of claim 14, wherein the criterion includes an author, and wherein the one or more processors implement the priority scheme by selecting an e-book from which a corresponding metadata content is to appear in the foreground of the stack representation based on one or more criteria that includes at least one of the author's most popular or widely sold title.

20. A non-transitory computer-readable medium that stores instructions for organizing e-books on a computing device, the computer-readable medium including instructions that, when executed by one or more processors, cause the one or more processors to perform operations comprising:
determining a criterion for defining a collection based on user input or data contained on the computing device;
identifying content items that are part of a user library and which are part of the collection based at least in part on the criterion; and
displaying a stack representation of the collection, including selecting content for a foreground of the stack representation, the content being specifically relevant to the collection.
identify a collection of content items, the content items of the collection being part of a user library of content items; and
display a stack representation of the collection;
wherein the one or more processors display the stack representation by (i) displaying metadata content from one or more content items of the collection, and (ii) implementing a priority scheme to select the metadata content of the content item that is to be displayed in a foreground of the stack representation.
